(19) United States
(12) Patent Application Publication
(10) Pub. No.: US 2009/0207043 A1
(43) Pub. Date: Aug. 20, 2009

(54) WIRELESS, INFRASTRUCTURELESS COMMUNICATION SYSTEM FOR VEHICLES AND METHOD FOR THE SAME

(75) Inventors: Aric David Shaffer, Ypsilanti, MI (US); Ronald Hugh Miller, Saline, MI (US); Gurpreet Aulakh, Brownstown Twp, MI (US); Dan Raceu, Warren, MI (US)

Correspondence Address: RADER, FISHMAN & GRAUER PLLC;FORD GLOBAL TECHNOLOGIES, INC., 39533 WOODARD AVENUE, SUITE #140, BLOOMFIELD HILLS, MI, 48304, US

(73) Assignee: FORD GLOBAL TECHNOLOGIES, INC, Dearborn, MI (US)

(21) Appl. No.: 12/034,099

(22) Filed: Feb. 20, 2008

(51) Int. Cl. G08G 1/00

(52) U.S. Cl. 340/903

(57) ABSTRACT

The present invention is a wireless, infrastructureless, communication system for vehicle to vehicle data transfer over a 900 MHz frequency over a substantially 360° radius of view over a predetermined range, preferably about 8 miles. Each vehicle is equipped with a geo-position system, a warning alert system, at least one sensor to produce a data signal indicative of vehicle operation conditions, a micro-chip set and a transceiver. The invention further includes methods to communicate over a wireless, infrastructureless communication system for vehicle to vehicle data transfer over the described system.

### TECHNICAL FIELD

Vehicle safety and convenience features continue to drive customer wants and needs in a technologically savvy economy. With global population growth and increasing numbers of drivers on the road utilizing electronics such as cell phones and navigation systems, the potential exists for increased driver distraction and potentially more accidents, requiring routing decisions by other drivers not directly involved in any accidents to avoid the accidents. Driver reaction time to hard braking events is critical, especially when subject to poor road conditions, such as low friction surfaces such as wet pavement, ice, snow, gravel or poor weather conditions such as fog, snow, ice or heavy rain. It is considered beneficial to implement a system to alert drivers of such conditions in advance of the drivers actually encountering them so that they could be better prepared to stop, avoid the accident or other unsafe condition, or revise their routes to avoid an accident and the congestion attendant with an accident.

The present invention, in one aspect, is a system for a wireless, infrastructureless communication system that facilitates communication between suitably equipped vehicles of operational status data, such as hard braking events, to permit a driver in a second car to anticipate the upcoming location or event and to react accordingly. The invention further relates to a method to communicate such information over a wireless, infrastructureless system. These and other aspects of the invention will become apparent upon a reading of the appended specification.

### SUMMARY OF THE INVENTION

In one aspect, the present invention relates to a wireless, infrastructureless, communication system for vehicle to vehicle data transfer. The system comprises at least two vehicles, each equipped with at least one sensor for producing signals indicative of vehicle operating conditions, a transceiver, an optional geo-position system (GPS), a micro-chip set adapted for wireless transmission of data signals over a predetermined distance indicative of vehicle operating conditions as warning data packets over a frequency of about 900 MHz over substantially a 360° field of view and a predetermined effective range radius. Each vehicle is further equipped with an operator warning alert system adapted to provide the vehicle operator with varying levels of warnings based upon the distance from a location where the second vehicle transmitted the warning data packet to the first vehicle. The system may also include a media gateway module and a navigation display.

The vehicle operating conditions useful in the present invention include hard braking events, road speed, wheel speed, location, road conditions and vehicle collision information. In this regard, the preferred sensors include at least one accelerometer, wheel speed sensor, road speed sensor, and brake sensor. These sensors produce signals indicative of the operational status or condition of the vehicle. These data signals are transmitted as warning data packets by a transceiver. The warning data packet includes information concerning location of transmitting vehicle, actual road speed, location of hard brake event, road conditions, collision location, time elapsed and alternative vehicle travel paths to avoid a receiving vehicle road travel delays.

Preferably, the warning alert signal increases in frequency or intensity, or both, as the first vehicle approaches the location where said second vehicle transmitted the warning data packet. The warning alert may be audio, visual, haptic and combinations thereof.

The present invention further relates to a method for wireless, infrastructureless communication between at least a first and second vehicle, each equipped with a transceiver, a GPS, a micro-chip set, at least one sensor to produce signals indicative of vehicle operating conditions, and a warning alert system responsive to warning data packets received from a remote vehicle. The method comprises determining a first vehicle operational status, determining whether a significant change in the first vehicle operation status has occurred, communicating the change in the first vehicle operation status to a second remote vehicle within a predetermined range, actuating an operator warning alert system in the second vehicle that varies in frequency or intensity, or both, based upon the distance between the location of the change of first vehicle operation status and the second vehicle. Preferably, the warning alert increases in frequency or intensity as the second vehicle approaches the location where the first vehicle transmitted the change in its operational status or condition. The warning alert may be audio, visual, haptic or combinations thereof. The communication between vehicles to advise of a change in a first vehicle operation status is communicated on a frequency of about 900 MHz over a substantially 360° radius of view over a predetermined distance, preferably about 8 miles.

### BRIEF DESCRIPTION OF THE DRAWINGS

FIG. 1 is a schematic representation of one embodiment of a system of the present invention.

FIG. 2 is a representation of one method of communicating over a system according to the present invention.

FIG. 3 is a representation of one method whereby a receiving vehicle reacts to the receipt of a warning data packet.

### DETAILED DESCRIPTION OF THE PREFERRED EMBODIMENT(S)

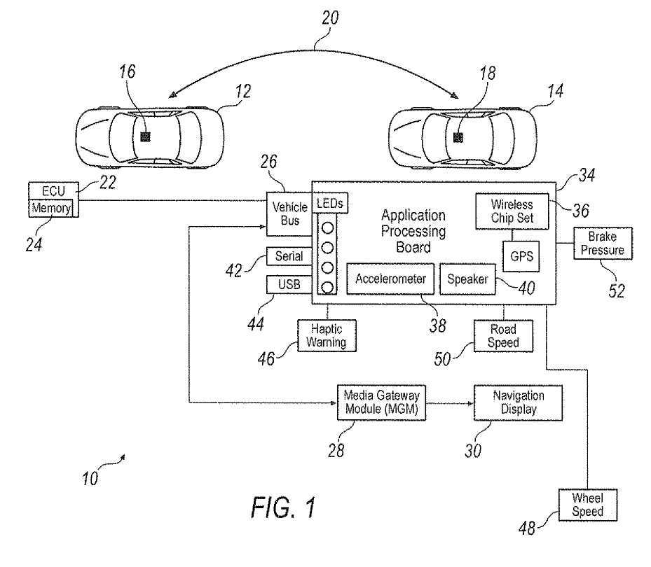

Turning to the drawings wherein like numbers refer to like structures, and particularly to FIG. 1, system 10 is comprised of at least two, and preferably a plethora of automobiles 12 and 14, respectively, each equipped with a transceiver 16 and 18, respectively, for the transmission and reception of warning data packets 20 representing changes in vehicle operational status of remote vehicles in order to provide the operators of vehicles receiving such warning data packets adequate time within which to react, by braking or slowing speed or changing routes, among other possible reactions. Each vehicle is electronically controlled by an ECU 22 having memory 24, that may be PROM, EPROM, EEPROM, FLASH, volatile or non volatile. The ECU is equipped with a vehicle bus 26 electronically connected to a media gateway module 28 and the media gateway module is electronically connected to a navigation display or monitor 30. The ECU is further electronically connected through the bus to an application processing board 34. Board 34 is equipped with a wireless chip set 36, such as “Moto Talk” that provides free wireless infrastructureless communication for vehicle to vehicle data transfer. The chip set generates signals that are to be transmitted by the transceiver at a predetermined frequency, preferably at about 900 MHz, over a 360° radius of view for a predetermined distance, preferably up to about 8 miles. The board is further equipped with an accelerometer 38 to assist in the detection of crashes or hard braking events, a geo-position system to permit the system to communicate the location of the transmitting vehicle, a speaker 40 to provide for audio alerts in the event of the receipt of a hard braking event or other change in operational status of a vehicle, and an LED, to provide visual warning alerts to an operator upon the receipt of a signal indicative of an accident or hard braking event. The system may optionally be equipped with a serial port 42 and a UBS port 44 for the input or download of data. The system may also include haptic warning system 46, such as vibration in a steering wheel or in an arm rest or seat to alert the operator to a change in a remote vehicle's operational status or condition. In this regard, various other sensors may be provided, such as wheel speed sensor 48 to produce signals indicative of actual vehicle wheel speed, road speed sensor 50 to produce signals indicative of changes in vehicle road speed, brake sensors, such as a brake pressure sensor 52 to produce data signal indicative of hard braking events by measuring the pressure applied to a brake during a braking event, among other sensors that may be electronically connected to the ECU to produce signals indicative of changes in vehicle operational status. The navigation display receives input from the media gateway module and the vehicle bus and displays vehicle location and maps and other aspects of a GPS system as is known in the art.

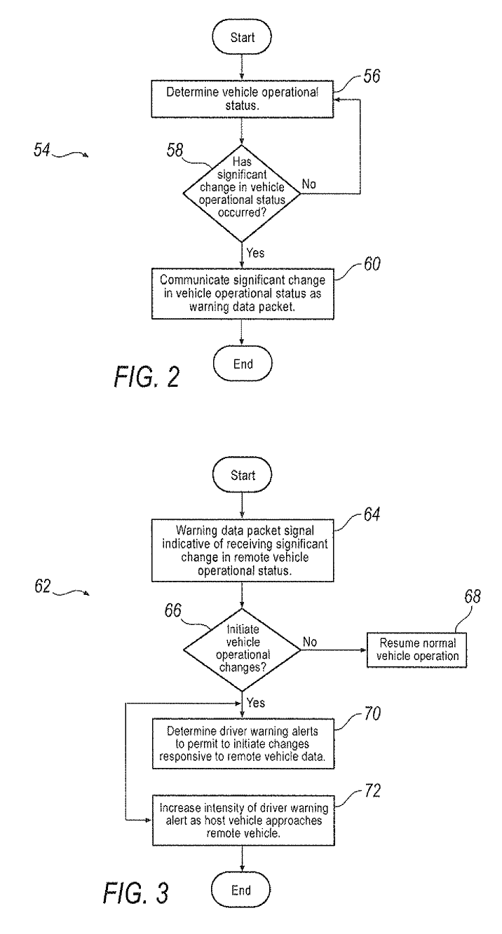

Turning now to FIG. 2, there is shown a software flow chart of one method 54 to communicate over a wireless, infrastructureless communication system as described above. Specifically, step 56 is determining a vehicle operational status. This is accomplished by the ECU and the input of various sensors indicative of data that is related to the vehicle's operational status. Step 58 is determining whether a significant change in vehicle operational status has occurred. This may arise if there is a hard braking event such as a sudden stop or deceleration event, or the wheel speed indicates that pavement is slippery, or if there is a hard braking event that may be detected by a pressure signal form the brakes indicative of the pressure applied during a braking event. If the pressure applied to the brake exceeds a predetermined amount, the ECU understands that a hard braking event has occurred. In another aspect, of the accelerometer may indicate a hard braking event. In addition, the accelerometer may indicate when an accident has occurred by indicating a sudden deceleration, and a signal is generated accordingly. If it is determined that no significant change in vehicle operational status has occurred, the software loops back to step 54. However, if it is determined that a significant change in vehicle operational status has occurred, step 60 is communicating the significant change in vehicle operational status as a warning data packet. Preferably, the warning data packet contains data indicative of the location of the change of operational event, and the manner of the change. This information is transmitted over the transceiver at about 900 MHz in a substantially 360° radius of view for a predetermined distance, from up to about 8 miles for receipt by vehicles similarly equipped with a transceiver.

FIG. 3 is another flow chart depicting one method 62 whereby the receiving vehicle reacts to the receipt of the warning data packet. Specifically, step 64 is receiving warning data packet signal indicative of a change in a remote vehicle operational status. Step 66 is determining whether to control the vehicle in accordance with said vehicle operational change. If no change has occurred, the engine continues to operate in a normal manner, as seen in step 68. If the determination is that there is a need to initiate changes in the vehicle in response to the received warning data signal, step 70 is to increase the frequency or intensity of the warning signal either audio, visual or haptic, or a combination of one or more of the foregoing, as the receiving vehicle draws closer to the locations from where the first vehicle sent the alarm and/or transmitted data signal indicative of vehicle operational change. In this regard, the system can operate in an audio sound that increases in volume or intensity or frequency as the vehicle approaches the location of the received warning packet. Similarly, visual displays, such as flashing LED lights, may intensify as the vehicle approaches the location where the received warning data packet was transmitted. Moreover, if the warning signal is haptic, the haptic event intensifies as the vehicle approaches the location from where the warning data packet was transmitted. Step 72 is activating the driver warning alerts to permit the driver to initiate changes in vehicle operation responsive to the warning data packages responsive to the remote vehicle data. These changes may include braking in anticipation of the sensed event, or plotting a new course of travel to avoid any slow downs or other trouble and congestion attendant with a vehicle accident, with the aid of the navigation system.

Those skilled in the art recognize that the words used in the specification are words of description, not words of limitation. Many variations and modifications are possible without departing form the scope and spirit of the invention as set forth in the appended claims.

We claim:

1. A wireless, infrastructureless, communication system for vehicle to vehicle data transfer, comprising:
at least two vehicles, each equipped with at least one sensor for producing signals indicative of vehicle operating conditions, a transceiver, a micro-chip set adapted for wireless transmission of data signals over a predetermined distance indicative of vehicle operating conditions as warning data packets over a frequency of about 900 MHz over substantially a 360° field of view and a predetermined effective range radius; said vehicle further equipped with an operator warning alert system adapted to provide said operator with varying levels of warnings based upon said distance from a location where said second vehicle transmits said warning data packet to said first vehicle.

2. The system of claim 1, wherein said warning alert increases in frequency as said first vehicle approaches said location where said second vehicle transmitted said warning data packet.

3. The system of claim 1, wherein said warning alert is at least an audio, visual, haptic and combinations thereof.

4. The system of claim 1, wherein said vehicle operating conditions include hard braking events deceleration events, road speed, wheel speed, location, road conditions and vehicle collision information.

5. The system of claim 1, wherein said sensor includes at least one accelerometer, wheel speed sensor, road speed sensor, and brake sensor.

6. The system of claim 1, further including a media gateway module and a navigation display.

7. The system of claim 1, wherein said warning data packet includes information concerning location of transmitting vehicle, actual road speed, location of hard brake event, road conditions, deceleration events, collision location, time elapsed and alternative vehicle travel paths to avoid a receiving vehicle road travel delays.

8. The system of claim 1, further including a Geo Position System (GPS).

9. A method for wireless, infrastructureless communication between at least a first and second vehicle; each said vehicle equipped with a transceiver, a micro-chip set, at least one sensor to produce signals indicative of vehicle operating conditions, and a warning alert system responsive to warning data packets received from a remote vehicle; comprising:
determining a first vehicle operational status;
determining whether a significant change in said first vehicle operation status has occurred;
communicating said change in said first vehicle operation status to a second remote vehicle within a predetermined range;
actuating an operator warning alert system in said second vehicle variable with a distance between a location of said change of first vehicle operation status and a second vehicle.

10. The method of claim 9, wherein said warning alert increases as said second vehicle approaches said location of said change of operational status of said first vehicle.

11. The method of claim 9, wherein said warning alert may be audio, visual, haptic or combinations thereof.

12. The method of claim 9, wherein said change in said first vehicle operation status is communicated on a frequency of about 900 MHz over a substantially 360° radius of view over a predetermined distance.

13. The method of claim 12, wherein said predetermined distance is about 8 miles.

14. The method of claim 9, further including a Geo Position System (GPS).
